(19) United States
(12) Patent Application Publication
(10) Pub. No.: US 2002/0195880 A1
(43) Pub. Date: Dec. 26, 2002

(54) Appliance and a power supply therefor

(76) Inventor: Tjerk Kornelis Bij De Leij, Drachten (NL)

Correspondence Address: Michael E. Marion, c/o PHILIPS ELECTRONICS NORTH AMERICA CORPORATION, Corporate Intellectual Property, 580 White Plains Road, Tarrytown, NY, 10591, US

(21) Appl. No.: 10/170,904

(22) Filed: Jun. 13, 2002

(30) Foreign Application Priority Data
Jun. 15, 2001 (EP) 01202308.1

(51) Int. Cl. H02B 1/24

(52) U.S. Cl. 307/115

(57) ABSTRACT

The invention relates to an appliance and a power supply therefor, having a stand-by mode and an active mode. The appliance comprises a work circuit (4), a primary circuit (23) which is connectable to a power source (25), a secondary circuit (24) which comprises a control circuit (32) for controlling a first switch (26) means acting on the work circuit (4) for selectively alternating between the active and the stand-by mode, and an adapting means (20) between the primary circuit (23) and the secondary circuit (24) for adapting in the stand-by mode the power from the primary circuit (23) to the secondary circuit (24) to requirements of the first switch means (26). According to the invention the primary circuit (23) comprises: voltage and/or current limiting means (27) to lower power from the primary circuit (23) to the secondary circuit (24) in correspondence with requirements of the control circuit (32), and a second switch means (28) acting on the limiting means (27) to disable the limiting means (27) in response to a signal from the control circuit (32) which indicates a change to the active mode and to enable the limiting means (27) in response to a signal from the control circuit (32) which indicates a reverse change. Power losses are considerably less and the configuration can be kept very simple while reliability is ensured nevertheless.

The present invention relates to an appliance, such as a water cooker, a kettle, a toaster, an audio or video apparatus etc. having a stand-by mode and an active mode and comprising:

a work circuit for performing a task of the appliance;

a primary circuit which is connectable to a power source so as to obtain power for the work circuit;

a secondary circuit comprising a control circuit for controlling a first switch means acting on the work circuit for selectively alternating between the active and the standby mode; and a current and/or voltage adapting means arranged between the primary circuit and the secondary circuit for adapting in the stand-by mode the power transferred from the primary circuit to the secondary circuit to power requirements of in particular the first switch means.

The present invention also relates to a power supply for an appliance, such as a water cooker, a kettle, a toaster, an audio or video apparatus etc. having a stand-by mode and an active mode, said power supply being connectable to a work circuit of the appliance for performing the task of the appliance and to a control circuit for controlling a first switch means acting on the work circuit for selectively alternating between the active and the standby mode and comprising

a primary circuit which is connectable to a power source to obtain power for the work circuit;

a secondary circuit which is connectable to the control circuit; and a current and/or voltage adapting means arranged between the primary circuit and the secondary circuit for adapting in the stand-by mode the power transferred from the primary circuit to the secondary circuit to power requirements of in particular the first switch means.

Such an appliance and a power supply therefor are generally known. A disadvantage of the known configurations is that the power transferred from the primary circuit to the secondary circuit is adapted to requirements of in particular the first switch means. Generally speaking such power requirements are comparatively high; for example, in the case of a relay switch serving as the first switch means, this is due to a comparatively large current required by the coil of the relay switch. In general, power requirements of the first switch means are such that the power loss in the standby mode is unacceptably high.

In the past, several solutions to this problem have been proposed. For example, U.S. Pat. No. 6,104,622 teaches the use in the primary circuit of means for intermittently supplying electrical current through the primary circuit, the current and/or voltage adapting means to the secondary circuit. The duty cycle and hence the power loss is thus said to be lowered. However, this solution is provided at the expense of a complex circuitry which raises the production costs to an undesired level. A similar solution having similar drawbacks is taught in U.S. Pat. No. 6,088,243.

The present invention has for an object to obviate, or at least decrease, the above mentioned disadvantages and drawbacks of the known apparatuses. A further aim is to provide a simple configuration while maintaining reliability of operation and correct functioning. To this end, the appliance according to the present invention is characterized in that the primary circuit comprises: voltage and/or current limiting means to lower in the stand-by mode the power transferred from the primary circuit to the secondary circuit in correspondence with power requirements of the control circuit, and a second switch means controlled by to the control circuit and acting on the voltage and/or current limiting means to disable the voltage and/or current limiting means in response to a signal from the control circuit which indicates a change from the stand-by mode to the active mode and to enable the voltage and/or current limiting means in response to a signal from the control circuit which indicates a reverse change. To this end, the power supply according to the invention is characterized in that the primary circuit comprises: voltage and/or current limiting means to lower in the stand-by mode the power transferred from the primary circuit to the secondary circuit in correspondence with power requirements of in particular the control circuit, and a second switch means controlled by the control circuit and acting on the voltage and/or current limiting means to disable the voltage and/or current limiting means in response to a signal from the control circuit which indicates a change from the stand-by mode to the active mode and to enable the voltage and/or current limiting means in response to a signal from the control circuit which indicates a reverse change.

In the standby mode the voltage and/or current limiting means limit the voltage and/or current in the primary circuit and, therefore, the power transferred to the secondary circuit, to a level which is sufficient to ensure correct functioning of the control circuit only, which power level is considerably less than the power required for operating the first switch means, thereby decreasing the power losses considerably. Current and/or voltage adapting means are designed to transfer the required voltage and/or current for correct functioning of the first switch means. However, in the standby mode the voltage and/or current limiting means limit the transfer to the level of power requirements of the control circuit, thereby considerably decreasing the power losses. When the control circuit outputs a signal indicating a change from the standby mode to the active mode, the second switch means are activated to disable the voltage and/or current limiting means, whereafter sufficient voltage and/or current is available to activate the first switch means in conformity with the designed transfer through the current and/or voltage adapting means.

In a preferred embodiment the first switch means and/or the second switch means can be realized as a relay switch. This is a preferred embodiment because of the simplicity of the circuitry involved. However, in such an embodiment the relay switch has to be provided so as to switch the second switch means, with a current which becomes available only after the voltage and/or current limiting means have been disabled by the second switch means, for which the relay switch is not supplied with sufficient current in that case. In order to achieve the desired switching behavior, in a further embodiment of the invention a charge device is connected to the relay switch via the control circuit, thus enabling discharging of the charge device through the relay switch in the case of a change from the standby mode to the active mode. The charge device then provides a current surge to the coil of the relay switch in response to the desired change from the standby mode to the active mode. The charge device is dimensioned and designed such, that the current surge is sufficient for the relay switch to act in particular on the second switch means.

Preferably, the charge device comprises a capacitor. Such an embodiment is conceivably the simplest way of realizing the charge device.

In a preferred embodiment the voltage and/or current limiting means comprises a resistor. In order to reduce the power consumption further, the voltage and/or current limiting means may comprise a capacitor. Either realization of the voltage and/or current limiting means is conceivably the simplest way of realizing the desired reduction of power losses.

Hereinbelow the present invention will be described in more detail, while referring to the accompanying drawings, in which the same reference numerals are used for the same or similar components, and in which:

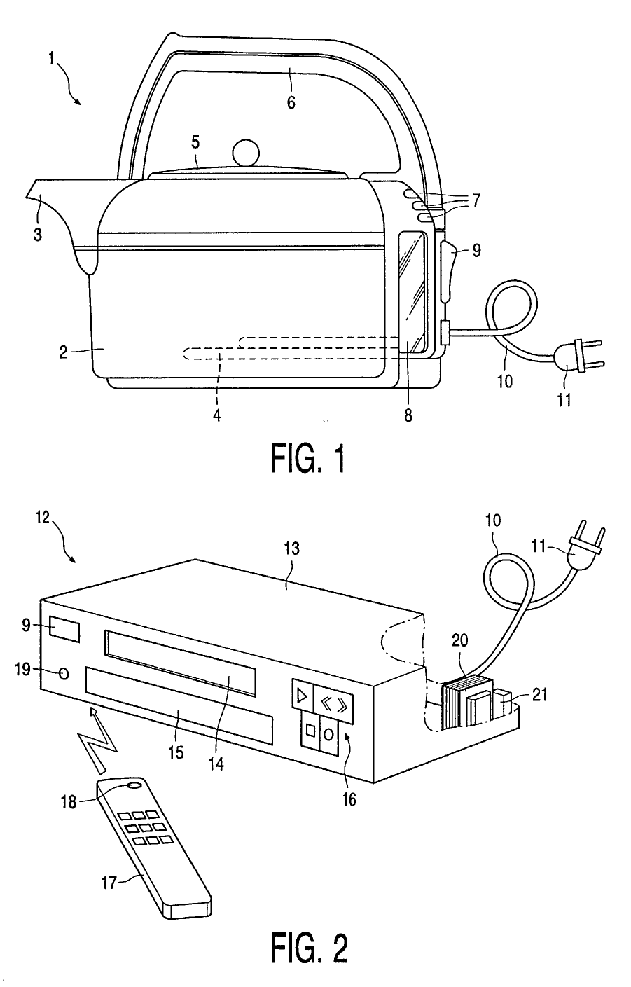

FIG. 1 and FIG. 2 show appliances as embodiments of the present invention; and

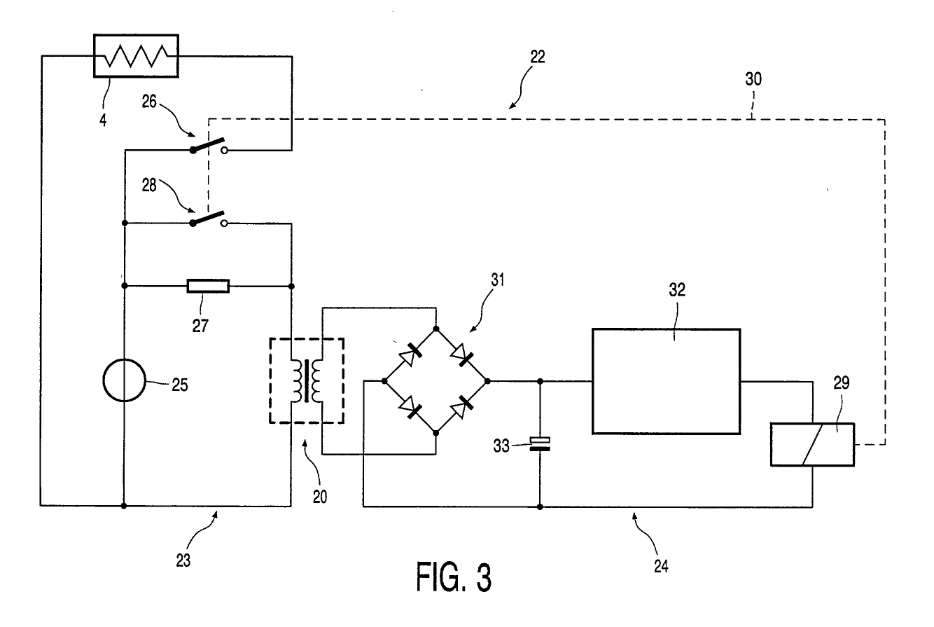

FIG. 3 shows schematically an electrical circuit in which the present invention is embodied.

FIG. 1 shows an electric kettle 1 as a feasible embodiment of an appliance according to the present invention. The kettle 1 comprises a hollow tank 2 with a spout 3; a heating element 4 extends into the interior of the hollow tank 2. An opening for filling the hollow tank 2 is covered by a lid 5 and the kettle 1 can be handled by a user by taking hold of a grip 6.

In this specific embodiment the hollow tank 2 is also provided with venting holes 7 to discharge steam from the interior of the hollow tank and with a sight glass 8 to visually inspect the water level in the hollow tank.

The kettle 1 also comprises a switch 9 for the user to alternate between a standby mode and an active mode of the kettle 1. The switch 9 interacts with a control circuit which is to be described in more detail hereinbelow. The kettle 1 can then remain connected to a power source, for example, a mains power source, via an electrical cable 10 with a plug 11 at its free end.

FIG. 2 shows another embodiment of the present invention. This embodiment is a video recorder which is shown in a partly broken away view.

The video recorder 12 comprises a housing 13 on the front of which there is provided an opening 14 for inserting and ejecting video tapes and also a display 15, and play mode selectors 16. The front of housing 13 also accommodates a switch 9 to selectively alternate between the standby mode and an active mode of the video recorder 12.

As is usual, the video recorder 12 comes with a remote control 17 which at least sends control signals to a receiver 19 which is also arranged on the front side of the housing 13, the remote control 17 being equipped with a switch 18 for selectively alternating between the standby mode and the active mode of the video recorder 12. The switches 9 and 18 (the latter through the receiver 19) interact with a control circuit to be described in more detail in relation to FIG. 3 hereinafter. It suffices to say that the signals from the switches 9 and 18 are applied to a circuit which also comprises a transformer 20 having on its primary side a primary circuit, (a housing 21 of which is shown in FIG. 2), and having on its secondary side a secondary circuit which comprises the above mentioned control circuit whereto signals are applied from the switches 9 and 18.

FIG. 3 shows schematically a circuit 22 according to the present invention. The circuit 22 comprises the heating element 4 of FIG. 1 as an embodiment of a work circuit of the appliance. Alternatively the work circuit could comprise components of the video recorder 12 shown in FIG. 2.

The circuit 22 also comprises a primary circuit 23 and a secondary circuit 24 which are interconnected by means of a transformer 20. The primary circuit 23 comprises a connection to a power source (here a mains power source 25), the heating element 4 being selectively connectable to the power source 25 via a switch 26 forming first switch means.

The primary side of the transformer 20 is connected to the power source 25 via a parallel configuration of a resistor 27, forming voltage and/or current limiting means, and a switch 28 which forming second switch means.

Both the switches 26 and 28 form part of a relay switch 29 which is denoted by dotted line 30. The relay switch 29 is part of the secondary circuit 24.

The secondary side of the transformer 20 is connected to a rectifier diode bridge 31 for rectification of the AC power applied to the secondary circuit 24 via the transformer 20. Rectified power from the rectifier 31 is applied to the control circuit 32 to ensure the desired functioning thereof. The control circuit 32 may be a microprocessor or the like.

The control circuit 32 controls the switches 28 and 26 of the relay switch 29 on the basis of signals received from the switches 9 and/or 18 as indicated in the FIGS. 1 and 2.

Between the rectifier 31 and the control circuit 32 there is arranged a capacitor 33 which forms a charge device.

The functioning of the circuit 22 of FIG. 3 is as follows. When the control circuit 32 receives from the switch 9 or the switch 18 a signal indicating that a user wishes to set the appliance in which the circuit 22 is arranged to a standby mode, the current to the coil of the relay switch 29 is controlled such that the switches 26 and 28 on the primary side are opened, i.e. that the heating element 4 is disconnected from the power source 25 and the short circuit of resistor 27 is cancelled, such that the resistor 27, forming the voltage and/or current limiting means, is enabled in the functioning thereof. The resistor 27 limits voltage and/or current to the primary side of the transistor 20 and, therefore, also to the secondary side thereof, as well as the secondary circuit 24. The resistor 27 is designed such that power transferred from the primary circuit 23 to the secondary circuit 24 suffices only for correct functioning of the control circuit 32, thus realizing a considerable decrease in power losses in the standby mode in a very simple manner.

In the standby mode the capacitor 33 is charged. When the control circuit 32 receives from a switch 9 and/or 18 a signal indicating that the user wishes to (re)activate the appliance, i.e. set it to its active mode, the control circuit 32 makes a connection between the capacitor 33 and the relay switch 29, resulting in discharge of the capacitor 33 across the coil of the relay switch 29. The capacitor 33 is designed such that the current surge resulting from this discharge is sufficient for the relay switch 29 to close at least the switch 28 so as to short-circuit the resistor 27. Thereafter, an unlimited voltage and/or current is applied to the primary side of the transformer 20 which adapts this voltage to a level required by the secondary circuit, and more in particular by the relay switch 29. The active mode of the circuit 22 can subsequently be maintained.

Replacement of the resistor 27 by a capacitor (not shown) enables a further decrease of the power losses in the standby mode.

Following the above description of the present invention above, various alternative and supplemental embodiments will immediately become apparent to a person skilled in the art. For example, closing the first and second switch means in the case of a change from the standby mode to the active mode can be achieved in a cascaded manner, that is, first closing the second switch means and only thereafter, when the voltage and/or current limiting means are disabled and the higher voltage and/or current is available in the secondary circuit after adaptation by the power adapting means, closing the first switch means so as to provide the working circuit with power from the power source. In the explicitly described embodiment of FIG. 3 the work circuit is described as being a heating element, in conformity with FIG. 1. However, as is shown in FIG. 2, the work circuit may also be formed by components of a video recorder that require a working voltage equal to that supplied by the power source. Furthermore, the work circuit could even be arranged elsewhere in the circuit shown in FIG. 3 and could conceivably even form a part of the secondary circuit.

1. An appliance, such as a water cooker, a kettle, a toaster, an audio or video apparatus etc. having a stand-by mode and an active mode and comprising:
a work circuit (4) for performing a task of the appliance;
a primary circuit (23) which is connectable to a power source (25) so as to obtain power for the work circuit (4);
a secondary circuit (24) comprising a control circuit (32) for controlling a first switch means (26) acting on the work circuit (4) for selectively alternating between the active and the stand-by mode; and
a current and/or voltage adapting means (20) arranged between the primary circuit (23) and the secondary circuit (24) for adapting in the stand-by mode the power transferred from the primary circuit (23) to the secondary circuit (24) to power requirements of in particular the first switch means (26);
where the primary circuit (23) comprises: voltage and/or current limiting means (27) to lower in the stand-by mode the power transferred from the primary circuit (23) to the secondary circuit (24) in correspondence with power requirements of the control circuit (32), and a second switch means (28) controlled by the control circuit (32) and acting on the voltage and/or current limiting means (27) to disable the voltage and/or current limiting means (27) in response to a signal from the control circuit (32) which indicates a change from the stand-by mode to the active mode and to enable the voltage and/or current limiting means (27) in response to a signal from the control circuit (32) which indicates a reverse change.

2. An appliance according to claim 1, wherein the second switch means (28) comprises a relay switch (29) controlled by the control circuit (32).

3. An appliance according to claim 1, wherein the first switch means (26) comprises a relay switch (29) controlled by the control circuit (32).

4. An appliance according to claim 2 or 3, wherein a charge device (33) is connected to the relay switch (29) via the control circuit (32), thus enabling discharging of the charge device (33) through the relay switch (29) in the case of a change from the stand-by mode to the active mode.

5. An appliance according to claim 4, wherein the charge device (33) comprises a capacitor.

6. An appliance according to claim 1, wherein the voltage and/or current limiting means (27) comprises a resistor.

7. An appliance according to claim 1, wherein the voltage and/or current limiting means (27) comprises a capacitor.

8. An appliance according to claim 1, wherein the voltage and/or current adapting means (20) comprises a transformer.

9. A power supply for an appliance, such as a water cooker, a kettle, a toaster, an audio or video apparatus etc. having a stand-by mode and an active mode, said power supply being connectable to a work circuit (4) of the appliance for performing the task of the appliance and to a control circuit (32) for controlling a a first switch means (26) acting on the work circuit (4) for selectively alternating between the active and the stand-by mode, and comprising
a primary circuit (23) which is connectable to a power source to obtain power for the work circuit (4);
a secondary circuit (24) which is connectable to the control circuit (32); and
a current and/or voltage adapting means (20) arranged between the primary circuit (23) and the secondary circuit (24) for adapting in the stand-by mode the power transferred from the primary circuit (23) to the secondary circuit (24) to power requirements of in particular the first switch means (26),
where the primary circuit (23) comprises: voltage and/or current limiting means (27) to lower in the stand-by mode the power transferred from the primary circuit (23) to the secondary circuit (24) in correspondence with power requirements of in particular the control circuit (32), and a second switch means (28) controlled by the control circuit (32) and acting on the voltage and/or current limiting means (27) to disable the voltage and/or current limiting means (27) in response to a signal from the control circuit (32) which indicates a change from the stand-by mode to the active mode and to enable the voltage and/or current limiting means (27) in response to a signal from the control circuit (32) which indicates a reverse change.
